(19) United States
(12) Patent Application Publication
(10) Pub. No.: US 2024/0340076 A1
(43) Pub. Date: Oct. 10, 2024

(54) COMMUNICATION METHOD AND APPARATUS

(71) Applicant: HUAWEI TECHNOLOGIES CO., LTD., Shenzhen (CN)

(72) Inventors: Yu WANG, Hangzhou (CN); Yunfei QIAO, Hangzhou (CN); Ying CHEN, Hangzhou (CN); Chuili KONG, Hangzhou (CN); Xiaolu WANG, Hangzhou (CN); Jun WANG, Hangzhou (CN)

(73) Assignee: HUAWEI TECHNOLOGIES CO., LTD., Shenzhen (CN)

(21) Appl. No.: 18/748,863

(22) Filed: Jun. 20, 2024

Related U.S. Application Data
(63) Continuation of application No. PCT/CN2022/134023, filed on Nov. 24, 2022.

(30) Foreign Application Priority Data
Dec. 21, 2021 (CN) 202111571536.5

(51) Int. Cl. H04B 7/185

(52) U.S. Cl. CPC H04B 7/18513; H04B 7/18519

(57) ABSTRACT

A communication method and apparatus are provided to reduce interference between different types of satellites. The method is: A terminal device determines a satellite type corresponding to a first area, and the terminal device determines, based on the satellite type, whether to access a network device covering the first area. The terminal device determines, based on the determined satellite type corresponding to the first area, whether the network device can be accessed, so that a type of the network device accessed by the terminal device is consistent with the satellite type of the first area, and the terminal device can access only one type of satellite. When a plurality of types of satellites reuse a same frequency, the terminal device may receive signals of the plurality of types of satellites in the first area.

### CROSS-REFERENCE TO RELATED APPLICATIONS

This application is a continuation of International Application No. PCT/CN2022/134023, filed on Nov. 24, 2022, which claims priority to Chinese Patent Application No. 202111571536.5, filed on Dec. 21, 2021. The disclosures of the aforementioned applications are hereby incorporated by reference in their entireties.

### TECHNICAL FIELD

Embodiments of this application relate to the field of communication technologies, and in particular, to a communication method and apparatus.

### BACKGROUND

With the development of a satellite network, the satellite network is generally ultra-dense and heterogeneous. The satellite network scales up from 66 satellites of the Iridium constellation to 720 satellites of the OneWeb constellation, and eventually extends to a starlink (Starlink) ultra-dense low earth orbit (LEO) satellite constellation with more than 12000 satellites. In addition, the satellite network is heterogeneous, and develops from a conventional single-layer communication network to a multi-layer communication network. The communication satellite network tends to have complicated and diversified functions, and is gradually compatible with and supports functions such as navigation enhancement, earth observation, and multi-dimensional information on-orbit processing.

Satellites can be divided into different types. Because of a high relative motion speed, it is difficult to directly establish inter-satellite communication links between different types of satellites, and coordination is difficult. As a result, real-time interference coordination cannot be performed.

### SUMMARY

An embodiment of this application provides a communication method, to reduce interference between different types of satellites.

According to a first aspect, a communication method is provided, applied to a non-terrestrial network NTN. The method may be performed by a terminal device or a chip, a chip system, or a circuit located in a terminal device located in the terminal device. The method may be implemented by using the following steps: The terminal device determines a satellite type corresponding to a first area; and the terminal device determines, based on the type, whether to access a network device covering the first area. The terminal device determines, based on the determined satellite type corresponding to the first area, whether the network device can be accessed, so that a type of the network device accessed by the terminal device is consistent with the satellite type of the first area, and the terminal device can access only one type of satellite. When a plurality of types of satellites reuse a same frequency, the terminal device may receive signals of the plurality of types of satellites in the first area. By using the foregoing method, the terminal device can access only a satellite whose type is the same as the satellite type of the first area. This can avoid a problem of co-channel interference and improve communication quality. In addition, different satellite types can reuse a same bandwidth. This can improve spectrum utilization.

With reference to the first aspect, the following provides several possible implementations in which the terminal device determines the satellite type corresponding to the first area.

Implementation 1: The terminal device receives a broadcast message in the first area, where the broadcast message includes information about the satellite type corresponding to the first area. In this implementation, the satellite type is indicated by display information.

Implementation 2: The terminal device may receive a broadcast message in the first area. The terminal device determines, based on a polarization direction of the broadcast message, the satellite type corresponding to the first area; or the broadcast message includes indication information of a first polarization direction, the terminal device determines, based on the indication information of the first polarization direction, the satellite type corresponding to the first area, and there is a one-to-one correspondence between a plurality of polarization directions and a plurality of satellite types. The satellite type is determined based on the polarization direction, so that overheads for indicating the satellite type can be reduced.

Implementation 3: The terminal device receives a first synchronization signal and physical downlink broadcast channel block SSB in the first area, and the terminal device determines, based on a frequency occupied by the first SSB, the satellite type corresponding to the first area, where there is a correspondence between one or more frequencies of one or more SSBs and one or more satellite types. For example, one satellite type may correspond to one or more frequencies. The satellite type is determined based on the correspondence between the frequencies and the satellite types, so that overheads for indicating the satellite type can be reduced.

Implementation 4: The terminal device determines, based on parity of a satellite orbit number corresponding to the first area, the satellite type corresponding to the first area, where there is a correspondence between the parity of the satellite orbit number and the satellite type. The satellite type is determined based on the correspondence between the parity of the satellite orbit number and the satellite type, so that overheads for indicating the satellite type can be reduced.

In a possible design, the terminal device may further obtain indication information of the first area, where the indication information of the first area includes any one or a combination of the following: a sequence number of the first area, an index of the first SSB, or information about a first frequency. The indication information of the first area may alternatively be carried in the broadcast message. A correspondence between the satellite type and the first area may be indicated by the indication information of the first area.

In a possible design, the terminal device may further obtain information about a first time period, where the first time period is effective time of the satellite type corresponding to the first area. The effective time is set for the satellite type, so that the satellite type corresponding to the area can be flexibly changed.

In a possible design, that the terminal device determines, based on the satellite type, whether to access a network device may be implemented in the following manner: The terminal device determines a first satellite type of the network device covering the first area; and if the first satellite type is the same as the satellite type corresponding to the first area, the terminal device determines to access the network device; or if the first satellite type is different from the satellite type corresponding to the first area, the terminal device determines not to access the network device. In this way, a service satellite of the terminal device in the first area may be only one type of satellite, so that a problem of co-channel interference is not caused in the first area.

Optionally, the satellite type may include an ascending orbit satellite or a descending orbit satellite.

According to a second aspect, a communication method is provided, applied to a non-terrestrial network NTN. The method may be performed by a terminal device or a chip, a chip system, or a circuit located in a terminal device. The method may be implemented by using the following steps: The terminal device accesses a service satellite, where a type of the service satellite is a first satellite type; the terminal device measures a satellite of a second satellite type to obtain a measurement result; and when the measurement result meets a measurement event, the terminal device reports a measurement report corresponding to the measurement event to the service satellite, where the measurement report is used to trigger the service satellite to perform interference coordination with the satellite of the second satellite type. In this way, on-demand interference management between different types of satellites can be implemented based on the inter-satellite measurement event of the terminal device. This improves efficiency of interference management.

In a possible design, the measurement event includes that signal quality of the satellite of the second satellite type is higher than a specified threshold in a specified time period.

According to a third aspect, a communication method is provided, applied to a non-terrestrial network NTN. The method may be performed by a terminal device or a chip, a chip system, or a circuit located in a terminal device. The method may be implemented by using the following steps: The terminal device obtains information of an electronic fence; and the terminal device performs a communication failure recovery process or a random access process based on the information of the electronic fence. In the presence of the electronic fence, the terminal device detects a link failure, and performs a corresponding random access process to implement communication failure recovery. However, in the area of the electronic fence, there is a high probability that the terminal device cannot reaccess an original network. The terminal device performs the communication failure recovery process or the random access process based on the information of the electronic fence, so that the communication failure recovery process is not repeatedly initiated in the area of the electronic fence. This reduces overheads.

In a possible design, that the terminal device performs a communication failure recovery process based on the information of the electronic fence may be implemented in the following manner: When a communication link failure occurs in a first area corresponding to the electronic fence, the terminal device keeps inactivity in a first time period corresponding to the electronic fence. The terminal device may keep inactivity in an unavailable frequency band in the first time period based on the information of the electronic fence, and no longer initiate the communication failure recovery process, so that resource consumption can be reduced.

In a possible design, that the terminal device performs a random access process based on the information of the electronic fence may be implemented in the following manner: Before a start moment of a first time period corresponding to the electronic fence, the terminal device hands over to a second area corresponding to an available frequency. In this way, the terminal device can hand over in advance, to maintain proper communication and improve communication quality.

According to a fourth aspect, a communication method is provided, applied to a non-terrestrial network NTN. The method may be performed by a terminal device or a chip, a chip system, or a circuit located in a terminal device. The method may be implemented by using the following steps: The terminal device determines satellite information corresponding to a first area covered by a network device, and determines, based on the satellite information, whether to access the network device. The satellite information may include information indicating whether the network device allows access of the terminal device. When a plurality of satellites reuse a same frequency, the terminal device may receive signals of the plurality of satellites in the first area. Whether access of the terminal device is allowed in the first area is indicated, so that the terminal device can access only a satellite that allows access of the terminal device. This avoids a problem of co-channel interference and improves communication quality.

In a possible design, if the satellite information indicates that the network device allows access of the terminal device, the terminal device determines to access the network device; or if the satellite information indicates that the network device does not allow access of the terminal device, the terminal device determines not to access the network device.

According to a fifth aspect, an embodiment of this application provides a communication apparatus. The apparatus is applied to a non-terrestrial network NTN. The apparatus has a function of implementing the method in any one of the foregoing aspects and the possible designs of the aspects. The communication apparatus includes a communication interface and a processor. The communication interface is used by the apparatus to communicate with another device, for example, receive and send data or a signal. For example, the communication interface may be a transceiver, a circuit, a bus, a module, or another type of communication interface, and the another device may be a network device or a node. The processor is configured to invoke a group of programs, instructions, or data, to perform the method described in any one of the foregoing aspects or the possible designs of the aspects. The apparatus may further include a memory, configured to store the programs, the instructions, or the data invoked by the processor. The memory is coupled to the processor. When executing the instructions or the data stored in the memory, the processor may implement the method described in any one of the foregoing aspects or the possible designs of the aspects.

According to a sixth aspect, an embodiment of this application further provides a computer-readable storage medium. The computer-readable storage medium stores computer-readable instructions. When the computer-readable instructions are run on a computer, the computer is enabled to perform the method according to any one of the aspects and the possible designs of the aspects.

According to a seventh aspect, an embodiment of this application provides a chip system. The chip system includes a processor, and may further include a memory, configured to implement the method according to any one of the foregoing aspects and the possible designs of the aspects. The chip system may include a chip, or may include a chip and another discrete component.

According to an eighth aspect, an embodiment of this application provides a communication system. The system includes a terminal device and a network device. The terminal device may perform the method according to any one of the foregoing aspects and the possible designs of the aspects.

According to a ninth aspect, a computer program product including instructions is provided. When the computer program product runs on a computer, the computer is enabled to perform the method according to any one of the foregoing aspects and the possible designs of the aspects.

For technical effects that can be achieved by the technical solutions in any one of the fifth aspect to the ninth aspect, refer to descriptions of technical effects that can be achieved by the technical solutions in any one of the first aspect to the fourth aspect. Details are not described herein again.

### BRIEF DESCRIPTION OF DRAWINGS

FIG. 1 is a schematic diagram of an architecture of a terrestrial network communication system according to an embodiment of this application;

FIG. 2 is a schematic diagram of an architecture of an NTN communication system according to an embodiment of this application;

FIG. 3 is a schematic diagram of an architecture of a 5G satellite communication system according to an embodiment of this application;

FIG. 4 is a schematic diagram of an architecture of a satellite communication system according to an embodiment of this application;

FIG. 5 is a schematic diagram of a beam hopping communication process according to an embodiment of this application;

FIG. 6 is a schematic diagram of an interference coordination solution according to an embodiment of this application;

FIG. 7 is a schematic diagram of a process of a communication method according to an embodiment of this application;

FIG. 8 is a schematic diagram of a satellite constellation intra-frequency reuse scenario according to an embodiment of this application;

FIG. 9 is a schematic flowchart of inter-satellite coordination based on a measurement event according to an embodiment of this application;

FIG. 10 is a schematic diagram of a process of another communication method according to an embodiment of this application;

FIG. 11 is a first schematic diagram of a structure of a communication apparatus according to an embodiment of this application; and

FIG. 12 is a second schematic diagram of a structure of a communication apparatus according to an embodiment of this application.

### DESCRIPTION OF EMBODIMENTS

Embodiments of this application provide a communication method and apparatus. The method and the apparatus are based on a same technical concept. Principles by which the method and the apparatus resolve a problem are similar. Therefore, embodiments of the apparatus and the method may be cross-referenced. A repeated part is not described again. In descriptions of embodiments of this application, the term “and/or” describes an association relationship between associated objects and indicates that three relationships may exist. For example, A and/or B may indicate the following three cases: Only A exists, both A and B exist, and only B exists. The character “/” generally indicates an “or” relationship between the associated objects. In this application, “at least one” means one or more, and “a plurality of” means two or more. In addition, it should be understood that, in the description of this application, the terms such as “first”, “second”, and “third” are merely used for distinguishing and description, and shall not to be understood as indication or implication of relative importance, or indication or implication of an order.

The communication method provided in embodiments of this application may be applied to a 4^{th} generation (4G) communication system, for example, a long term evolution (long term evolution, LTE) system; may be further applied to a 5^{th} generation (5G) communication system, for example, 5G new radio (NR); or may be applied to various future communication systems, for example, a 6^{th} generation (6G) communication system. The method provided in embodiments of this application may be applied to a terrestrial network communication system, or may be applied to a non-terrestrial network (NTN) communication system.

The following describes in detail embodiments of this application with reference to accompanying drawings.

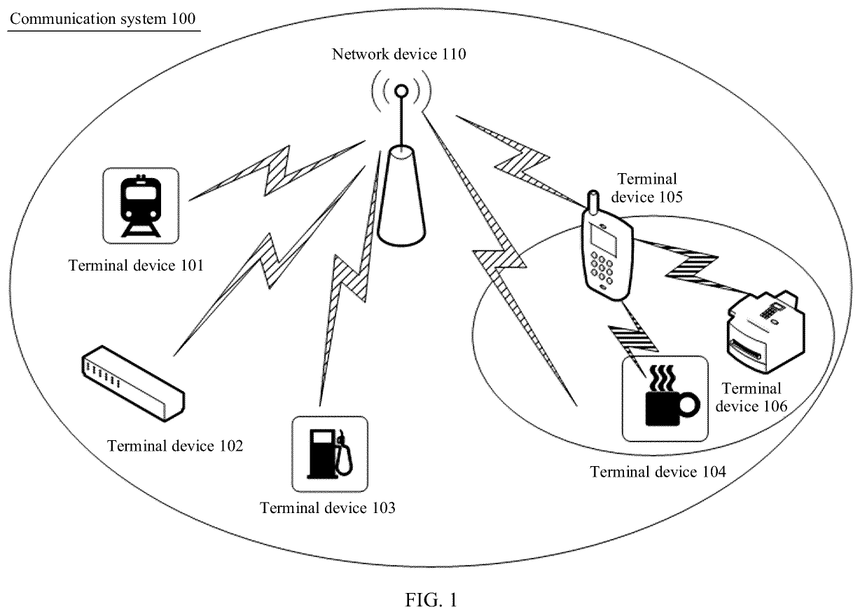

FIG. 1 shows a possible architecture of a terrestrial network communication system to which a communication method according to an embodiment of this application is applicable. The communication system 100 may include a network device 110 and terminal devices 101 to 106. It should be understood that the communication system 100 may include more or fewer network devices or terminal devices. The network device or the terminal device may be hardware, or may be software obtained through function division, or may be a combination thereof. In addition, the terminal devices 104 to 106 may also form a communication system. For example, the terminal device 105 may send downlink data to the terminal device 104 or the terminal device 106. The network device or the terminal device may communicate with each other through another device or network element. The network device 110 may send downlink data to the terminal devices 101 to 106, or may receive uplink data sent by the terminal devices 101 to 106. Certainly, the terminal devices 101 to 106 may also send uplink data to the network device 110, or may receive downlink data sent by the network device 110.

The network device 110 is a node in a radio access network (RAN), and may also be referred to as a base station or a RAN node (or device). Currently, for example, the access network device 110 may be a gNB/NR-NB, a transmission reception point (TRP), an evolved NodeB (eNB), a radio network controller (RNC), a NodeB (NB), a base station controller (BSC), a base transceiver station (BTS), a home base station (for example, a home evolved NodeB or a home NodeB, HNB), a baseband unit (BBU), a wireless fidelity (Wi-Fi) access point (AP), a network device in a 5G communication system, or a network device in a future possible communication system. The network device 110 may alternatively be another device that has a network device function. For example, the network device 110 may alternatively be a device that functions as a network device in D2D communication. The network device 110 may alternatively be a network device in a future possible communication system.

The terminal devices 101 to 106 each may also be referred to as user equipment (UE), a mobile station (MS), a mobile terminal (MT), or the like, and is a device that provides a user with voice or data connectivity, or may be an internet of things device. For example, the terminal devices 101 to 106 each include a handheld device, a vehicle-mounted device, or the like that has a wireless connection function. Currently, the terminal devices 101 to 106 each may be a mobile phone (mobile phone), a tablet computer, a notebook computer, a palmtop computer, a mobile internet device (MID), a wearable device (for example, a smartwatch, a smart band, or a pedometer), a vehicle-mounted device (for example, a vehicle-mounted device on an automobile, a bicycle, an electric vehicle, an aircraft, a ship, a train, or a high-speed train), a virtual reality (VR) device, an augmented reality (AR) device, a wireless terminal in industrial control (industrial control), a smart home device (for example, a refrigerator, a television, an air conditioner, or an electricity meter), an intelligent robot, a workshop device, a wireless terminal in self driving (self driving), a wireless terminal in remote medical surgery (remote medical surgery), a wireless terminal in a smart grid (smart grid), a wireless terminal in transportation safety (transportation safety), a wireless terminal in a smart city (smart city), a wireless terminal in a smart home (smart home), a flight device (for example, an intelligent robot, a hot balloon, an uncrewed aerial vehicle, or an aircraft), or the like. The terminal devices 101 to 106 may alternatively be other devices that have a terminal function. For example, the terminal devices 101 to 106 may alternatively be devices that functions as a terminal in D2D communication.

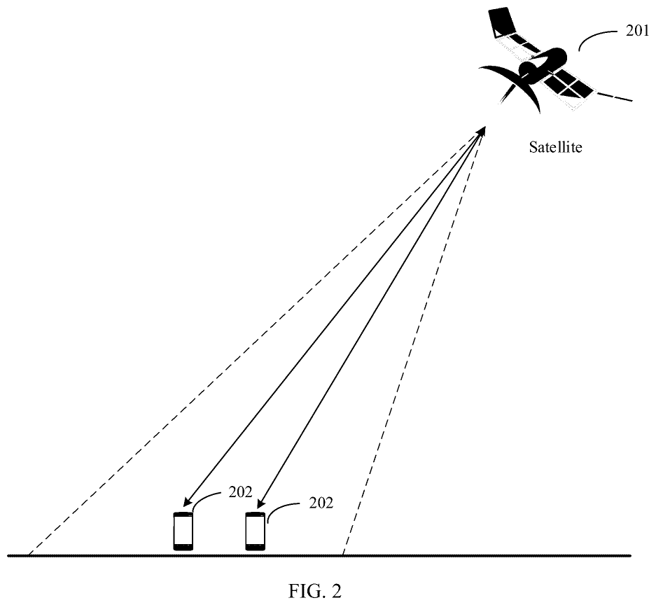

Based on the description of the architecture of the terrestrial network communication system shown in FIG. 1, the communication method provided in this embodiment of this application is applicable to an NTN communication system. An NTN includes nodes such as satellite networks, high-altitude platforms, and uncrewed aerial vehicles. The NTN features global coverage, long-distance transmission, flexible networking, convenient deployment, and no geographical restrictions, and has been widely used in many fields such as maritime communication, positioning and navigation, emergency rescue and disaster relief, scientific experiment, video broadcast, and earth observation. A terrestrial 5G network, a satellite network, and the like are integrated, to gather strengths and overcome a weakness, jointly form a sea-land-air-space-ground integrated communication network of global seamless coverage, and meet ubiquitous service requirements of a user. In embodiments of this application, for example, NTN communication is satellite communication, in other words, an NTN communication system is a satellite system. As shown in FIG. 2, the NTN communication system includes a satellite 201 and terminal devices 202. For explanation of the terminal devices 202, refer to the related descriptions of the terminal devices 101 to 106. The satellite 201 may also be referred to as a high-altitude platform, a high-altitude aircraft, or a satellite base station. When the NTN communication system is associated with the terrestrial network communication system, the satellite 201 may be considered as one or more network devices in the architecture of the terrestrial network communication system. The satellite 201 provides a communication service for the terminal devices 202, and the satellite 201 may further be connected to a core network device. For a structure and a function of the network device 110, refer to the foregoing descriptions of the network device 110. For a communication manner between the satellite 201 and the terminal device 202, refer to the descriptions in FIG. 1. Details are not described herein.

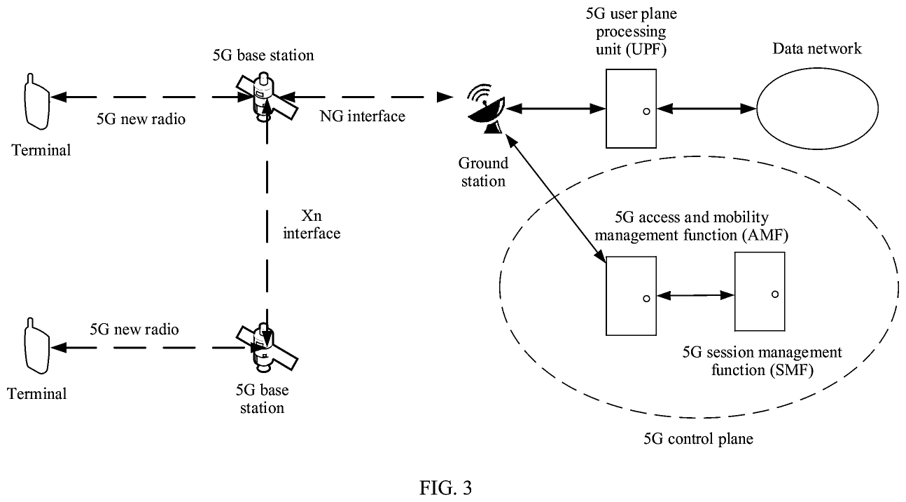

5G is used as an example. An architecture of a 5G satellite communication system is shown in FIG. 3. A terrestrial terminal device accesses a network through 5G new radio. A 5G base station is deployed on a satellite, and is connected to a terrestrial core network through a radio link. In addition, a radio link exists between satellites, to perform signaling interaction and user data transmission between base stations. Devices and interfaces in FIG. 3 are described as follows:

A 5G core network provides services such as user access control, mobility management, session management, user security authentication, and accounting. The 5G core network includes a plurality of functional units, which can be classified into control-plane functional entities and data-plane functional entities. An access and mobility management unit (AMF) is responsible for user access management, security authentication, and mobility management. A user plane unit (UPF) is responsible for functions such as user plane data transmission management and traffic statistics.

A ground station is responsible for forwarding signaling and service data between a satellite base station and a 5G core network.

5G new radio is a radio link between a terminal and a base station.

An Xn interface is an interface between a 5G base station and a base station, and is mainly used for signaling exchange such as handover.

An NG interface is an interface between a 5G base station and a 5G core network, and mainly exchanges signaling such as NAS signaling from the core network and user service data.

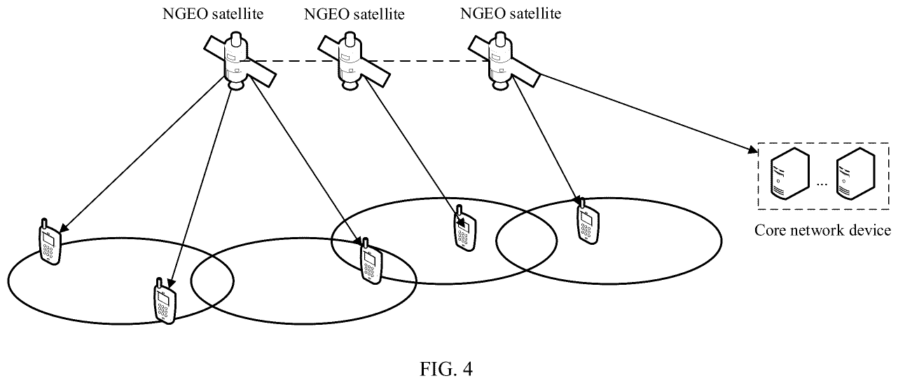

FIG. 4 is a schematic diagram of an architecture of another possible satellite communication system to which this application is applicable. If an analogy is made between the satellite communication system and the terrestrial communication system, a satellite may be considered as one or more network devices on the ground, for example, a base station, an access point 1, an access point 2, and even access points 3 to n (not shown in the figure). The satellite provides communication services for a terminal device, and the satellite may also be connected to a core network device (for example, an access and mobility management function (AMF)). The satellite may be a non-geostationary earth orbit (NGEO) satellite or a geostationary earth orbit (GEO) satellite. An NGEO satellite is used as an example in FIG. 4.

The network device in the terrestrial network communication system and the satellite in the NTN communication system are both considered as network devices. An apparatus configured to implement a function of a network device may be a network device or may be an apparatus that can support the network device in implementing the function, for example, a chip system. The apparatus may be mounted in the network device. When the technical solutions provided in embodiments of this application are described below, an example in which an apparatus configured to implement a function of a network device is a satellite is used to describe the technical solutions provided in embodiments of this application. It may be understood that, when the method provided in embodiments of this application is applied to the terrestrial network communication system, an action performed by the satellite may be performed by a base station or a network device.

In embodiments of this application, an apparatus configured to implement a function of a terminal device may be a terminal device, or may be an apparatus that can support the terminal device in implementing the function, for example, a chip system. The apparatus may be mounted in the terminal device. In this embodiment of this application, the chip system may include a chip, or may include a chip and another discrete component. In the technical solutions provided in embodiments of this application, an example in which the apparatus configured to implement a function of a terminal device is a terminal device is used to describe the technical solutions provided in embodiments of this application.

For ease of understanding of embodiments of this application, an application scenario of this application is described below. A service scenario described in embodiments of this application is intended to describe the technical solutions of embodiments of this application more clearly, and does not constitute a limitation on the technical solutions provided in embodiments of this application. It may be learned by a person of ordinary skill in the art that, with the emergence of a new service scenario, the technical solutions provided in embodiments of this application are also applicable to a similar technical problem.

A coverage area of a satellite may reach thousands or even tens of thousands of kilometers, and a coverage area of a beam may reach tens or even thousands of meters. To support wide-area coverage of a satellite, tens, hundreds, or even more beams usually need to be configured for the satellite. To alleviate a contradiction between a small load and a wide coverage area of a single satellite, beam hopping may be used for area coverage. To be specific, a large quantity of beams may be configured for the satellite to cover a wide area, but only a small quantity of beams are used in a same time unit to cover the area, and a wide area is covered by using a plurality of beams used in different time units. For example, as shown in FIG. 5, 16 beams are configured for a satellite to cover a wide area, but only four beams are used in one time unit for area coverage. In a time unit T1, four beams numbered 0, 1, 4, and 5 are used for area coverage. In a time unit T2, four beams numbered 2, 3, 6, and 7 are used for area coverage. By analogy, all areas (namely, areas corresponding to the 16 beams) covered by a single satellite are served in a time division manner of T1, T2, T3, and T4. A time unit may be dozens of milliseconds, several milliseconds, or even a smaller time granularity. In a satellite communication network, a plurality of beams are configured in a satellite, and each beam may be considered as a beam in a cell or a separate cell. A satellite beam is a shape formed on the earth surface by an electromagnetic wave emitted by a satellite antenna, and has a specific range just like a beam of a flashlight; or a signal emitted by a satellite is not 360-degree radiation, but a signal wave emitted in a specific direction.

An inter-satellite link (ISL) is a communication link between satellites, which can effectively reduce a communication delay and relieve dependence on ground stations. The ISL is an important channel for signaling information exchange between satellites, which lays a foundation for near-real-time coordination between a plurality of satellites. However, different from a terrestrial network, the satellite network has a high dynamic nature and makes deployment of the ISL subject to many constraints such as a long distance of the ISL and a high relative motion speed. For example, in an inclined orbit constellation, the relative motion speed between ascending and descending orbit satellites is large. Consequently, a single-hop ISL cannot be directly established, and coordination between the ascending and descending orbit satellites can be realized only after a long distance and a number of hops. In this case, a propagation delay may reach hundreds of milliseconds or even seconds. Inter-satellite coordination cannot be performed at a small time granularity (for example, at a millisecond level or at a frame level), and therefore interference coordination cannot be completed. For example, interference coordination may be inter-satellite, inter-cell, inter-frame, or inter-subframe interference coordination.

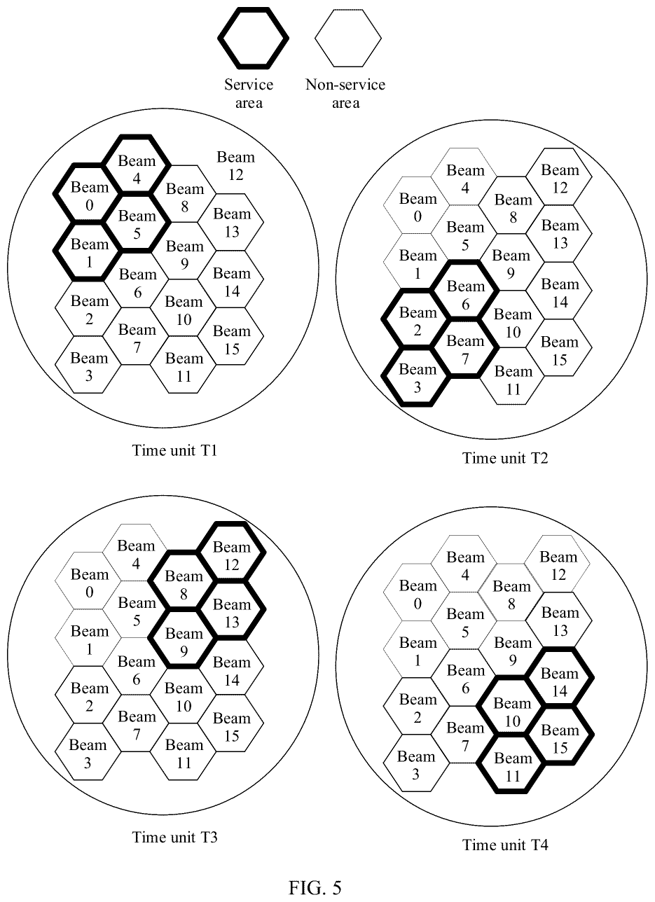

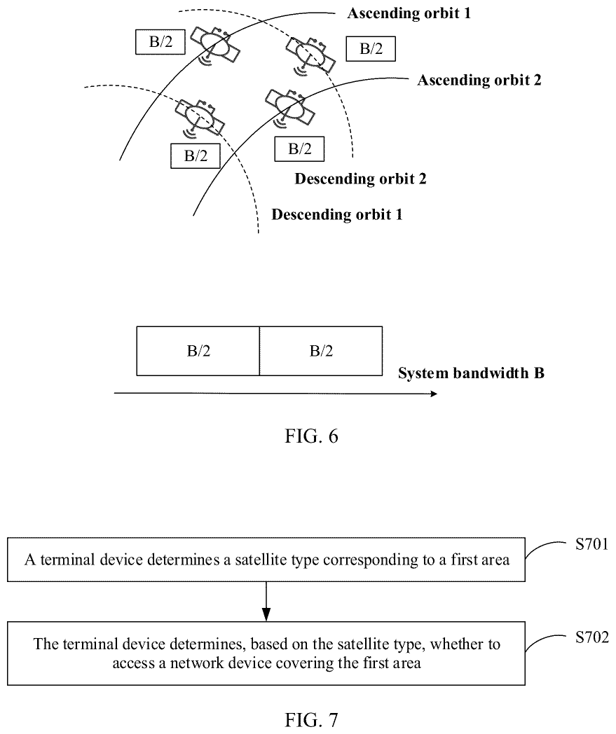

As shown in FIG. 6, in an interference coordination solution, an entire system bandwidth is divided into a plurality of parts through static resource allocation, where an ascending orbit satellite (moving from south to north) and a descending orbit satellite (moving from north to south) avoid inter-satellite interference in a frequency division/polarization multiplexing manner. For example, the system bandwidth is divided into two parts. The ascending orbit satellite uses ½ bandwidth, and the descending orbit satellite uses the other ½ bandwidth. Although this solution can effectively resolve the interference problem of the ascending and descending orbit satellites, spectrum utilization is very low.

Based on this, an embodiment of this application provides a communication method. As shown in FIG. 7, a process of the communication method provided in this embodiment of this application is described as follows.

S701: A terminal device determines a satellite type corresponding to a first area.

S702: The terminal device determines, based on the satellite type, whether to access a network device covering the first area.

The terminal device determines, based on the determined satellite type corresponding to the first area, whether the network device covering the first area can be accessed, so that a type of the network device accessed by the terminal device is consistent with the satellite type of the first area, and the terminal device can access only one type of satellite. When a plurality of types of satellites reuse a same frequency, the terminal device may receive signals of the plurality of types of satellites in the first area. By using the foregoing method, the terminal device can access only a satellite whose type is the same as the satellite type of the first area. This avoids a problem of co-channel interference and improves communication quality. In addition, different satellite types can reuse a same bandwidth. This can improve spectrum utilization.

### Optional Implementations of the Embodiment in FIG. 7 are Described Below

A satellite may be used as an example for describing the network device in this embodiment of this application. It may be understood that the network device may alternatively be another device other than the satellite.

The satellite type may include an ascending orbit satellite or a descending orbit satellite. The ascending orbit satellite may be a satellite moving from south to north, and the descending orbit satellite may be a satellite moving from north to south. The satellite type may alternatively have another definition. This is not limited in this application. In addition, one satellite may correspond to one cell, or may correspond to a plurality of cells.

In this embodiment of this application, co-channel interference can be avoided for an intra-frequency reuse scenario. Intra-frequency reuse means that different types of satellites reuse a same bandwidth. For example, a carrier bandwidth is represented by B, and both the ascending orbit satellite and the descending orbit satellite can use the entire carrier bandwidth B. Because there is no single-hop Xn interaction between the ascending and descending orbit satellites, co-channel interference may occur in the intra-frequency reuse scenario, resulting in communication quality deterioration or even a communication failure. In this embodiment of this application, a satellite type of an area is pre-defined for the area, and the terminal device can access only a satellite of the satellite type corresponding to the area. In this way, a problem of co-channel interference can be avoided.

The “area” in embodiments of this application may also be referred to as a “beam position”, a “cell”, or a “beam coverage area”, or may also be referred to as another name. An area is a geographical area of a range. An area may be a coverage area of a beam, or may be a coverage area of one or more cells. For example, as shown in FIG. 5, 16 beam coverage areas are configured for a satellite, and an area covered by a beam may be referred to as a beam position or an area.

In the intra-frequency reuse scenario, an area may be covered by a plurality of satellites, and a terminal device in the area may receive signals from the plurality of satellites. A network side preconfigures a service satellite type corresponding to a specified area in a specific time period, for example, an ascending orbit satellite corresponding to an area 1 and a descending orbit satellite corresponding to an area 2.

Before accessing the network device, the terminal device determines a satellite type of the network device, for example, determines that the satellite type of the network device is an ascending orbit or a descending orbit. The terminal device may determine the satellite type based on ephemeris information of the satellite. The terminal device compares the satellite type of the network device with the satellite type corresponding to the first area. If the first satellite type is the same as the satellite type corresponding to the first area, the terminal device determines to access the network device; or if the first satellite type is different from the satellite type corresponding to the first area, the terminal device determines not to access the network device. For example, the first area corresponds to the ascending orbit satellite. If the terminal device determines that the network device is an ascending orbit satellite, the terminal device determines to access the network device. If the terminal device determines that the network device is a descending orbit satellite, the terminal device determines not to access the network device. When the terminal device receives signals of a satellite 1 and a satellite 2 in the first area, the satellite 1 is an ascending orbit satellite, the satellite 2 is a descending orbit satellite, and the first area corresponds to the ascending orbit satellite, the terminal device accesses the satellite 1 but does not access the satellite 2. In this way, a service satellite of the terminal device in the first area may be only an ascending orbit satellite, so that a problem of co-channel interference is not caused in the first area. It may be understood that inter-satellite coordination may be performed between different satellites of a same satellite type through a single-hop connection, and a problem of co-channel interference does not exist. In the foregoing example, an example in which the first area corresponds to the ascending orbit satellite is used. When the first area corresponds to the descending orbit satellite, a determining manner is similar.

In a possible design, a satellite type corresponding to an area has timeliness. To be specific, a satellite type corresponding to an area is not always one type, and may change with time, or may change based on a configuration on the network side. For example, the first area corresponds to the first satellite type in a first time period, and the first area corresponds to a second satellite type in a second time period. The terminal device may further obtain information about the first time period, where the first time period is effective time of the satellite type corresponding to the first area. The first time period may be implemented by using a timer, and the information about the first time period may be at least two of the following: a start moment, a time length, and an end moment. The terminal device may start a timer when determining the satellite type corresponding to the first area. When the timer is running, the first area corresponds to one satellite type. After the timer expires, the terminal device needs to obtain information about a satellite type corresponding to the first area again. The obtained satellite type may be the same as or different from the satellite type in the first time period. In addition, timeliness may also be determined based on a location or a relative location relationship. For example, a distance between UE and a reference point is less than a specific threshold, to determine timeliness of the satellite type. In this way, the terminal device can access only a satellite whose type is the same as the satellite type of the first area in a specific time period. This better avoids a problem of co-channel interference.

The following uses an example to describe a manner in which the terminal device obtains the satellite type corresponding to the first area.

The terminal device may receive a broadcast message or system information. An example in which the terminal device receives a broadcast message is used for description. The broadcast message may come from one or more network devices. The network device that the terminal device determines, based on the satellite type, whether to access may be one of the one or more network devices.

In a possible design, the broadcast message includes information about the satellite type. The terminal device determines, based on the information about the satellite type included in the broadcast message, the satellite type corresponding to the first area. For example, one bit indicates the satellite type, where 0 indicates the ascending orbit satellite, and 1 indicates the descending orbit satellite. When a value of a field indicating the satellite type in the broadcast message is 0, the terminal device determines that the first area corresponds to the ascending orbit satellite. When the value of the field indicating the satellite type is 1, the terminal device determines that the first area corresponds to the descending orbit satellite. The terminal device may receive the broadcast message in the first area, and determine the service satellite type of the first area based on the broadcast message. Alternatively, the broadcast message includes indication information of the first area. After receiving the broadcast message, the terminal device may determine, based on the indication information of the first area and a satellite type field, the satellite type corresponding to the first area. The indication information of the first area may be any one or a combination of the following: a sequence number of the first area, an index (index) of a synchronization signal and physical downlink broadcast channel block (SSB), or information about a first frequency. The network side may divide a wide area covered by the network device in advance, a plurality of divided areas are respectively numbered, and each area has a corresponding sequence number. For example, the sequence number of the first area may be a beam position number. An area corresponds to indexes of one or more SSBs. The terminal device may determine the first area based on the index of the received SSB. Different areas correspond to different frequency information. The terminal device receives a signal from a satellite, for example, a broadcast signal or a reference signal, at the first frequency, and may determine a current area based on frequency information. It may be understood that the broadcast message may carry a plurality of satellite types corresponding to a plurality of areas, for example, may further include a satellite type corresponding to a second area. The first time period may alternatively be carried in the broadcast message.

The indication information of the first area, the information about the first time period, and the satellite type may be carried in a same message (for example, the broadcast message or another type of message), or may be carried in different messages. The following uses an example to describe a correspondence among an area, a time period, and a satellite type with reference to Table 1.

TABLE 1

| Area | Time period | Satellite type |
|---|---|---|
| Area 1/SSB 1/Frequency f1 | Timer 1/T1-T2 | Ascending orbit |
| Area 2/SSB 3/Frequency f3 | Timer 2/T3-T4 | Descending orbit |
| Area 3/SSB 4/Frequency f4 | Timer 3/T5-T6 | Ascending orbit |
| . . . | . . . | . . . |

Alternatively, the terminal device may determine the satellite type based on a polarization direction of the broadcast message. In this case, there is a correspondence between the polarization direction and the satellite type. The polarization direction may include left hand circular polarization (LHCP) and right hand circular polarization (RHCP). There may be a one-to-one correspondence between polarization directions and satellite types. For example, two polarization directions are in a one-to-one correspondence with two satellite types. For example, the LHCP corresponds to the ascending orbit and the RHCP corresponds to the descending orbit. Alternatively, the LHCP corresponds to the descending orbit, and the RHCP corresponds to the ascending orbit. The network side and the terminal device may agree on the correspondence between the polarization directions and the satellite types in advance. The terminal device may determine the polarization direction of the broadcast message, and the terminal device may determine, based on the determined polarization direction and the correspondence between the polarization directions and the satellite types, the satellite type corresponding to the first area. In another manner, the broadcast message may carry indication information of the polarization direction of the broadcast message, for example, indicating a first polarization direction. The terminal device may determine, based on the indication information of the first polarization direction and the correspondence between the polarization directions and the satellite types, the satellite type corresponding to the first area.

It may be understood that the terminal device may alternatively determine the satellite type based on a polarization direction of a message other than the broadcast message. A determining manner is similar to that in the broadcast message solution.

Alternatively, the terminal device may determine the satellite type based on parity of a satellite orbit number. There is a correspondence between the parity of the satellite orbit number and the satellite type. For example, the satellite orbit number is an odd number and corresponds to the ascending orbit satellite; or the satellite orbit number is an even number and corresponds to the descending orbit satellite. For another example, the satellite orbit number is an even number and corresponds to the ascending orbit satellite; or the satellite orbit number is an odd number and corresponds to the descending orbit satellite. The network side and the terminal device may agree on the correspondence between the parity of the satellite orbit number and the satellite type in advance. The terminal device may determine the satellite type corresponding to the first area based on the parity of the satellite orbit number corresponding to the first area and the correspondence between the parity of the satellite orbit number and the satellite type.

Alternatively, the terminal device may determine the satellite type based on information about a frequency occupied by the synchronization signal and physical downlink broadcast channel block (SS/PBCH block, SSB). The SSB includes a primary synchronization signal (PSS), a secondary synchronization signal (SSS), and a PBCH. There is a correspondence between the frequency occupied by the SSB and the satellite type. For example, the correspondence between the frequency of the SSB and the satellite type is: An occupied frequency f1 corresponds to the ascending orbit satellite, and an occupied frequency f2 corresponds to the descending orbit satellite. If the terminal device receives the SSB at the frequency f1, the terminal device determines that the satellite type is the ascending orbit satellite. If the terminal device receives the SSB at the frequency f2, the terminal device determines that the satellite type is the descending orbit satellite.

The following further describes the embodiment in FIG. 7 in detail with reference to a specific application scenario.

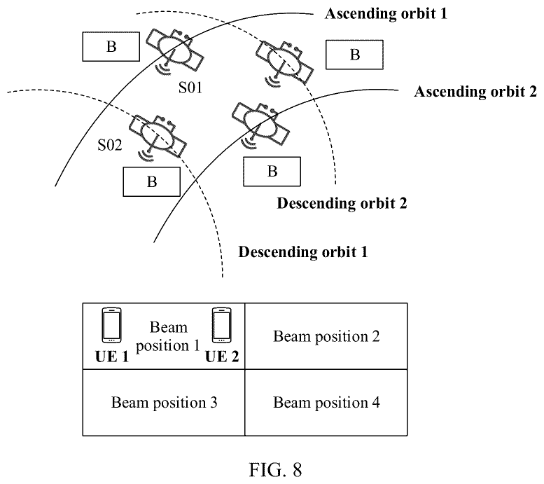

As shown in FIG. 8, there are two types of satellites: an ascending orbit satellite and a descending orbit satellite. Satellite orbit sequence numbers include an ascending orbit 1, an ascending orbit 2, a descending orbit 1, and a descending orbit 2. S01 is an ascending orbit satellite and S02 is a descending orbit satellite. A bandwidth of each satellite is the carrier bandwidth B. There are four beam positions represented by a beam position 1, a beam position 2, a beam position 3, and a beam position 4. Because a plurality of satellites reuse the carrier bandwidth B, the terminal device may receive signals from the plurality of satellites in one beam position. The terminal device is represented by UE 1. The UE 1 may receive signals of the ascending orbit satellite S01 and the descending orbit satellite S02 in the beam position 1. The UE 1 determines that a satellite type corresponding to the beam position 1 is an ascending orbit satellite, and the UE 1 determines, based on an ephemeris message of the satellite (for example, based on speed information included in ephemeris), that the satellite S01 is an ascending orbit satellite. In this case, the UE 1 determines that the S01 can be accessed in the beam position 1. The UE 1 determines that the satellite type corresponding to the beam position 1 is the ascending orbit satellite, and the UE 1 determines, based on the ephemeris of the satellite, that the satellite S02 is a descending orbit satellite. In this case, the UE 1 determines that the S02 cannot be accessed in the beam position 1.

Based on a same technical concept as the embodiment in FIG. 7, this application may further provide another communication method. A process of the method is as follows: The terminal device determines satellite information corresponding to the first area covered by the network device, and determines, based on the satellite information, whether to access the network device. The satellite information may include information indicating whether the network device allows access of the terminal device. If the satellite information indicates that the network device allows access of the terminal device, the terminal device determines to access the network device; or if the satellite information indicates that the network device does not allow access of the terminal device, the terminal device determines not to access the network device.

In the solution of the embodiment in FIG. 7, the satellite type is specific to the first area, that is, the satellite type is indicated for the area. This application further provides a communication method. Different satellite types of satellites perform a relay service for an area in a time division manner. For example, a first-type satellite serves the first area in the first time period, a second-type satellite serves the first area in the second time period after the first time period, the first-type satellite serves the first area in a third time period after the second time period. The rest is deduced by analogy. In this way, different types of service satellites alternately serve the first area in the time division manner. For example, the satellite S01 serves the beam position 1 in a time period T1-T2, the satellite S02 serves the beam position 1 in a time period T2-T3, the satellite S01 serves the beam position 1 in a time period T3-T4, and the satellite S02 serves the beam position 1 in a time period T4-T5. T1-T2, T2-T3, T3-T4, and T4-T5 are four continuous time periods on a time axis. Certainly, several time periods of the relay service may not be strictly continuous, that is, there is a gap between two time periods.

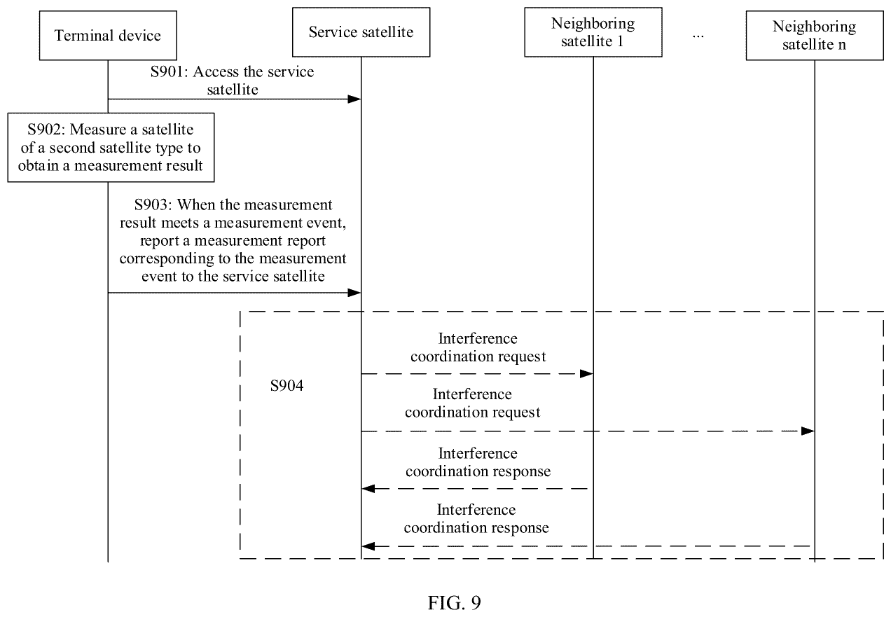

Based on a same technical concept, this application further provides a communication method. As shown in FIG. 9, a specific process of the method is described as follows.

S901: A terminal device accesses a service satellite, where a type of the service satellite is a first satellite type.

S902: The terminal device measures a satellite of a second satellite type to obtain a measurement result.

S903: When the measurement result meets a measurement event, the terminal device reports a measurement report corresponding to the measurement event to the service satellite, where the measurement report is used to trigger the service satellite to perform interference coordination with the satellite of the second satellite type.

The measurement event includes that signal quality of the satellite of the second satellite type is higher than a specified threshold in a specified time period.

The terminal device may receive a measurement configuration from the service satellite. The measurement configuration may include information such as a frequency of a measured cell, a measurement gap, a reporting threshold (threshold), or a measurement event type.

For example, the measurement event may include the following two types represented by X1 and X2.

Measurement event X1: The service satellite is an ascending orbit satellite, and signal quality of the descending orbit satellite measured in a specific time period is higher than a specific first threshold (threshold1). Measurement event X2: The service satellite is a descending orbit satellite, and signal quality of the ascending orbit satellite measured in a specific time period is higher than a specific second threshold (threshold2).

The signal quality includes reference signal received power (RSRP), a reference signal signal-to-noise and interference ratio (RS-SINR), reference signal received quality (RSRQ), a reference signal received signal strength indicator (RS-RSSI), a signal to interference plus noise ratio, or the like.

After receiving the measurement configuration, the terminal device measures a neighboring satellite or a neighboring cell, and reports a measurement result to the service satellite when a reporting condition is met. When the service satellite is the ascending orbit satellite, measurement is performed based on the measurement event X1. If the service satellite is the descending orbit satellite, measurement is performed based on the measurement event X2.

After S903, optionally S904 may be further included.

S904: After receiving the measurement report from the terminal device, the service satellite separately interacts with the neighboring satellite or a ground station in the measurement report.

Specifically, the service satellite sends an interference coordination request to the neighboring satellite, and after receiving the interference coordination request, the neighboring satellite returns an interference coordination response to the service satellite.

According to the solution in the embodiment in FIG. 9, on-demand interference management between different types of satellites can be implemented based on the inter-satellite measurement event of the terminal device. This improves efficiency of interference management.

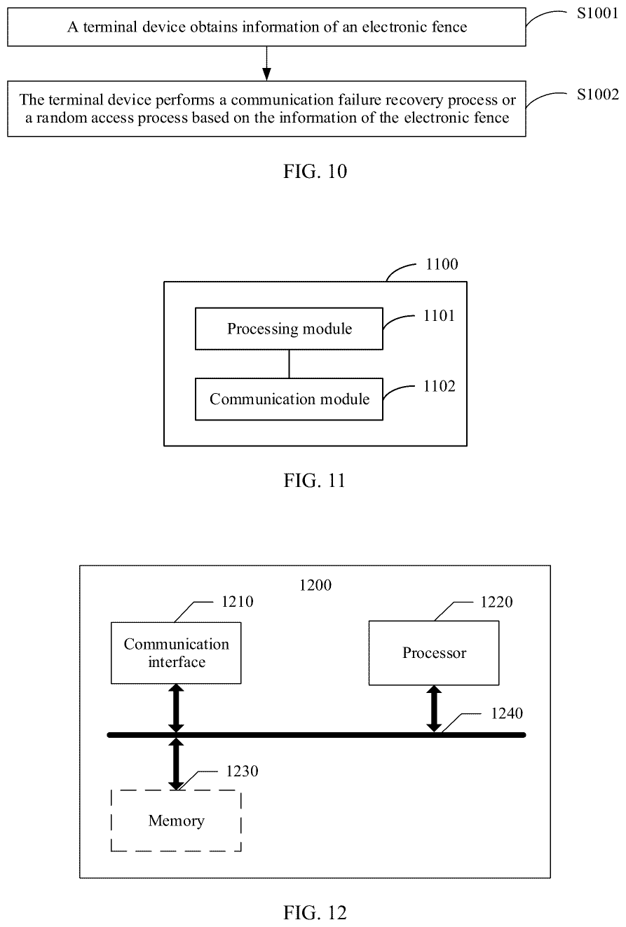

Based on a same technical concept, this application further provides a communication method. As shown in FIG. 10, a specific process of the method is described as follows.

S1001: A terminal device obtains information of an electronic fence.

S1002: The terminal device performs a communication failure recovery process or a random access process based on the information of the electronic fence.

The electronic fence indicates that one or more specified frequencies are unavailable in a specified area in a specified time period. The terminal device may obtain the information of the electronic fence by using a broadcast message. The information of the electronic fence may include information about an area, information about a time period, and information about a frequency band. For example, a format of the information of the electronic fence is bwp_barred {beam position, bwp-id, time period}. A bwp_barred information element is an unavailable bandwidth part (BWP), and bwp-id is an identifier of the bandwidth part. Optionally, the information of the electronic fence may alternatively indicate an available bandwidth part. The terminal device may determine an unavailable bandwidth part in a specified area in a specified time period based on indication information of the available bandwidth part and/or the unavailable bandwidth part.

In the presence of the electronic fence, the terminal device detects a link failure, and performs a corresponding random access process to implement communication failure recovery. However, in the area of the electronic fence, there is a high probability that the terminal device cannot reaccess an original network. In this embodiment of this application, the terminal device may perform the communication failure recovery process or the random access process based on the information of the electronic fence.

In an implementation 1, when a communication link failure occurs in a first area corresponding to the electronic fence, the terminal device keeps inactivity in a first time period corresponding to the electronic fence. The information of the electronic fence indicates that a first bandwidth part is an unavailable frequency band in the first area in the first time period. In this case, the terminal device may keep inactivity in the unavailable frequency band in the first time period based on the information of the electronic fence, and no longer initiate the communication failure recovery process in the frequency band, so that resource consumption is reduced. The terminal device may use the implementation 1 according to an agreement. Alternatively, the terminal device may use the implementation 1 based on indication of a network device. For example, the network device sends indication information to the terminal device. The indication information indicates the terminal device to keep inactivity, or the indication information indicates the terminal device to perform the communication failure recovery process. The indication information may be an inactivity index (Inactivity Index) in a beam failure recovery configuration (Beam Failure Recovery Config) information element in NR, or may be an inactivity index in a newly defined information element. For example, if a value of the inactivity index is 0 (or 1), it indicates that the terminal device enters an inactivity state, that is, does not initiate random access. If the value of the inactivity index is 1 (or 0), it indicates that a failure recovery process of NR is reused. The indication information may be carried by using one or more of the following: a system information block (SIB), a medium access control element (MAC CE), radio resource control (RRC), or the like.

In an implementation 2, before a start moment of a first time period corresponding to the electronic fence, the terminal device hands over to a second area corresponding to an available frequency. The first time period is, for example, a timer. Before the timer expires, the terminal device hands over in advance to a satellite (or a cell, or a beam) corresponding to the available frequency. In this way, the terminal device can hand over in advance, to maintain proper communication and improve communication quality.

As shown in FIG. 11, based on a same technical concept, an embodiment of this application further provides a communication apparatus 1100. The communication apparatus 1100 may be a terminal device, or may be a function component, a module, or the like in a terminal device, or may be another apparatus that can match a terminal device for use. In a design, the communication apparatus 1100 may include modules that are in a one-to-one correspondence with the methods/operations/steps/actions performed by the terminal device in the foregoing method embodiment. The module may be implemented by a hardware circuit, software, or a combination of a hardware circuit and software. In a design, the communication apparatus 1100 may include a processing module 1101 and a communication module 1102.

When the communication apparatus 1100 is configured to perform the embodiment shown in FIG. 7, the processing module 1101 is configured to determine a satellite type corresponding to a first area, and configured to determine, based on the satellite type, whether to access a network device covering the first area. The communication module 1102 is configured to communicate with another apparatus.

Optionally, when determining the satellite type corresponding to the first area, the communication module 1102 is configured to receive a broadcast message in the first area, where the broadcast message includes information about the satellite type.

Optionally, when determining the satellite type corresponding to the first area, the communication module 1102 is configured to receive a broadcast message in the first area. The processing module 1101 is specifically configured to determine, based on a polarization direction of the broadcast message, the satellite type corresponding to the first area. Alternatively, the communication module 1102 is configured to receive a broadcast message in the first area, where the broadcast message includes indication information of a first polarization direction, and the processing module 1101 is specifically configured to determine, based on the indication information of the first polarization direction, the satellite type corresponding to the first area. There is a one-to-one correspondence between a plurality of polarization directions and a plurality of satellite types.

Optionally, when determining the satellite type corresponding to the first area, the communication module 1102 is configured to receive a first synchronization signal and physical downlink broadcast channel block SSB in the first area. The processing module 1101 is specifically configured to determine, based on a frequency occupied by the first SSB, the satellite type corresponding to the first area. There is a correspondence between one or more frequencies of one or more SSBs and one or more satellite types.

Optionally, when the terminal device determines the satellite type corresponding to the first area, the processing module 1101 is specifically configured to determine, based on parity of a satellite orbit number corresponding to the first area, the satellite type corresponding to the first area. There is a correspondence between the parity of the satellite orbit number and the satellite type.

Optionally, the processing module 1101 is further configured to obtain indication information of the first area, where the indication information of the first area includes any one or a combination of the following: a sequence number of the first area, an index of the first SSB, or information about a first frequency.

Optionally, the processing module 1101 is further configured to obtain information about a first time period, where the first time period is effective time of the satellite type corresponding to the first area.

Optionally, when determining, based on the satellite type, whether to access the network device, the processing module 1101 is specifically configured to: determine a first satellite type of the network device; and

if the first satellite type is the same as the satellite type corresponding to the first area, determine an access network device; or if the first satellite type is different from the satellite type corresponding to the first area, determine not to access the network device.

Optionally, the satellite type includes an ascending orbit satellite or a descending orbit satellite.

When the communication apparatus 1100 is configured to perform the embodiment in FIG. 9, the processing module 1101 is configured to access a service satellite, where a type of the service satellite is the first satellite type, and configured to measure a satellite of a second satellite type to obtain a measurement result; and configured to: when the measurement result meets a measurement event, report a measurement report corresponding to the measurement event to the service satellite, where the measurement report is used to trigger the service satellite to perform interference coordination with the satellite of the second satellite type. The communication module 1102 is configured to communicate with another apparatus.

Optionally, the measurement event includes that signal quality of the satellite of the second satellite type is higher than a specified threshold in a specified time period.

When the communication apparatus 1100 is configured to perform the embodiment in FIG. 10, the processing module 1101 is configured to: obtain information of an electronic fence; and perform a communication failure recovery process or a random access process based on the information of the electronic fence. The communication module 1102 is configured to communicate with another apparatus.

Optionally, when performing the communication failure recovery process based on the information of the electronic fence, the processing module 1101 is configured to: when a communication link failure occurs in a first area corresponding to the electronic fence, keep inactivity in a first time period corresponding to the electronic fence.

Optionally, when the terminal device performs the random access process based on the information of the electronic fence, the processing module 1101 is configured to: before a start moment of a first time period corresponding to the electronic fence, hand over to a second area corresponding to an available frequency.

The processing module 1101 and the communication module 1102 may be further configured to perform other corresponding operations performed by the terminal device in the foregoing method embodiment. Details are not described herein again.

Division into the modules in embodiments of this application is an example, is merely division into logical functions, and may be other division during actual implementation. In addition, functional modules in embodiments of this application may be integrated into one processor, or each of the modules may exist alone physically, or two or more modules may be integrated into one module. The integrated module may be implemented in a form of hardware, or may be implemented in a form of a software functional module.

FIG. 12 shows a communication apparatus 1200 according to an embodiment of this application. The communication apparatus 1200 is configured to implement functions of the terminal device in the foregoing method. The communication apparatus 1200 may be a terminal device, may be an apparatus in a terminal device, or may be an apparatus that can match a terminal device for use. The communication apparatus may be a chip system. In this embodiment of this application, the chip system may include a chip, or may include a chip and another discrete component. The communication apparatus 1200 includes at least one processor 1220, configured to implement a function of the terminal device in the method provided in embodiments of this application. The communication apparatus 1200 may further include a communication interface 1210. The communication interface 1210 may be a transceiver, a circuit, a bus, a module, or another type of communication interface, and is configured to communicate with another device through a transmission medium. For example, the communication apparatus 1200 communicates with another device through the communication interface 1210.

The communication apparatus 1200 may further include at least one memory 1230. The memory 1230 is configured to store program instructions and/or data. The memory 1230 is coupled to the processor 1220. The coupling in this embodiment of this application is indirect coupling or a communication connection between apparatuses, units, or modules for information exchange between the apparatuses, the units, or the modules, and may be in electrical, mechanical, or other forms. The processor 1220 may cooperate with the memory 1230. The processor 1220 may execute the program instructions stored in the memory 1230. At least one of the at least one memory may be included in the processor. The processor 1220 may be implemented by using a logic circuit, and a specific form includes but is not limited to any one of the following.

The processor 1220 may be a central processing unit (CPU), a network processor (NP), or a combination of a CPU and an NP. The processor 1220 may be implemented by using a logic circuit. A specific form of the foregoing logic circuit includes but is not limited to any one of the following: a field-programmable gate array (FPGA), a very high speed integrated circuit hardware description language (VHDL) circuit, or a complementary pass transistor logic (CPL) circuit.

When the communication apparatus 1200 is configured to implement the foregoing method embodiment, the processor 1220 is configured to implement a function of the foregoing processing module 1101, and the communication interface 1210 is configured to implement a function of the foregoing communication module 1102.

When the communication apparatus is a chip used in a terminal device, the chip in the terminal device implements a function of the terminal device in the foregoing method embodiments. The chip in the terminal device receives information from another module (for example, a radio frequency module or an antenna) in the terminal device, where the information is sent by a network device to the terminal device. Alternatively, the chip in the terminal device sends information to another module (for example, a radio frequency module or an antenna) in the terminal device, where the information is sent by the terminal device to a network device. A specific connection medium between the communication interface 1210, the processor 1220, and the memory 1230 is not limited in embodiments of this application. In this embodiment of this application, the memory 1230, the processor 1220, and the communication interface 1210 are connected to each other through a bus 1240 in FIG. 12. The bus is represented by using a bold line in FIG. 12. A connection manner between other components is merely an example for description, and is not limited thereto. The bus may be classified into an address bus, a data bus, a control bus, and the like. For ease of representation, only one bold line indicates the bus in FIG. 12, but this does not mean that there is only one bus or only one type of bus.

In this embodiment of this application, the memory 1230 may be a non-volatile memory, for example, a hard disk drive (HDD) or a solid-state drive (SSD), or may be a volatile memory (volatile memory), for example, a random-access memory (RAM). The memory is any other medium that can carry or store expected program code in a form of an instruction structure or a data structure and that can be accessed by a computer, but is not limited thereto. The memory in embodiments of this application may alternatively be a circuit or any other apparatus that can implement a storage function, and is configured to store the program instructions and/or the data.

Some or all of the operations and functions performed by the terminal device/network device described in the foregoing method embodiments of this application may be implemented by using a chip or an integrated circuit.

To implement the functions of the communication apparatus in FIG. 11 or FIG. 12, an embodiment of this application further provides a chip, including a processor, configured to support the communication apparatus in implementing the functions of the terminal device or the network device in the foregoing method embodiment. In a possible design, the chip is connected to a memory or the chip includes the memory, and the memory is configured to store program instructions and data that are necessary for the communication apparatus.

An embodiment of this application provides a computer-readable storage medium storing a computer program. The computer program includes instructions for performing the foregoing method embodiments.

An embodiment of this application provides a computer program product including instructions. When the computer program product runs on a computer, the computer is enabled to perform the foregoing method embodiments.

The method steps in embodiments of this application may be implemented by hardware, or may be implemented by the processor executing software instructions. The software instructions may include a corresponding software module. The software module may be stored in a random access memory, a flash memory, a read-only memory, a programmable read-only memory, an erasable programmable read-only memory, an electrically erasable programmable read-only memory, a register, a hard disk, a removable hard disk, a CD-ROM, or any other form of storage medium well-known in the art. For example, a storage medium is coupled to the processor, so that the processor can read information from the storage medium and write information into the storage medium. Certainly, the storage medium may be a component of the processor. The processor and the storage medium may be disposed in an ASIC. In addition, the ASIC may be located in a base station or a terminal. Certainly, the processor and the storage medium may exist in the base station or the terminal as discrete components.

All or some of the foregoing embodiments may be implemented by using software, hardware, firmware, or any combination thereof. When software is used to implement the embodiments, all or some of the embodiments may be implemented in a form of a computer program product. The computer program product includes one or more computer programs and instructions. When the computer programs or instructions are loaded and executed on a computer, all or some of the processes or functions in embodiments of this application are executed. The computer may be a general-purpose computer, a dedicated computer, a computer network, a network device, user equipment, or another programmable apparatus. The computer programs or instructions may be stored in a computer-readable storage medium, or may be transmitted from a computer-readable storage medium to another computer-readable storage medium. For example, the computer programs or instructions may be transmitted from a website, computer, server, or data center to another website, computer, server, or data center in a wired or wireless manner. The computer-readable storage medium may be any usable medium that can be accessed by a computer, or a data storage device, for example, a server or a data center, integrating one or more usable media. The usable medium may be a magnetic medium, for example, a floppy disk, a hard disk, or a magnetic tape; or may be an optical medium, for example, a digital video disc; or may be a semiconductor medium, for example, a solid-state drive. The computer-readable storage medium may be a volatile or non-volatile storage medium, or may include two types of storage media: a volatile storage medium and a non-volatile storage medium.

In various embodiments of this application, unless otherwise stated or there is a logic conflict, terms and/or descriptions in different embodiments are consistent and may be mutually referenced, and technical features in different embodiments may be combined based on an internal logical relationship thereof, to form a new embodiment.

“A plurality of” in this application means two or more than two. The term “and/or” describes an association relationship between associated objects and indicates that three relationships may exist. For example, A and/or B may indicate the following cases: Only A exists, both A and B exist, and only B exists, where A and B may be singular or plural.

It may be understood that various numbers in embodiments of this application are merely used for differentiation for ease of description, and are not used to limit the scope of embodiments of this application. The sequence numbers of the foregoing processes do not mean execution sequences, and the execution sequences of the processes should be determined based on functions and internal logic of the processes.

What is claimed is:

1. A communication method, applied to a non-terrestrial network (NTN), comprising:
determining, by a terminal device, a satellite type corresponding to a first area; and
determining, by the terminal device based on the satellite type, whether to access a network device covering the first area.

2. The method according to claim 1, wherein the determining, by a terminal device, a satellite type corresponding to a first area comprises:
receiving, by the terminal device, a broadcast message in the first area, wherein the broadcast message comprises information about the satellite type corresponding to the first area.

3. The method according to claim 1, wherein the determining, by a terminal device, a satellite type corresponding to a first area comprises:
receiving, by the terminal device, a broadcast message in the first area, and determining, by the terminal device based on a polarization direction of the broadcast message, the satellite type corresponding to the first area; or receiving, by the terminal device, a broadcast message in the first area, wherein the broadcast message comprises indication information of a first polarization direction, and determining, by the terminal device based on the indication information of the first polarization direction, the satellite type corresponding to the first area, wherein
there is a one-to-one correspondence between a plurality of polarization directions and a plurality of satellite types.

4. The method according to claim 1, wherein the determining, by a terminal device, a satellite type corresponding to a first area comprises:
receiving, by the terminal device, a first synchronization signal and physical downlink broadcast channel block (SSB) in the first area; and
determining, by the terminal device based on a frequency occupied by the first SSB, the satellite type corresponding to the first area, wherein
there is a correspondence between one or more frequencies of one or more SSBs and one or more satellite types.

5. The method according to claim 1, wherein the determining, by a terminal device, a satellite type corresponding to a first area comprises:
determining, by the terminal device based on parity of a satellite orbit number corresponding to the first area, the satellite type corresponding to the first area, wherein there is a correspondence between the parity of the satellite orbit number and the satellite type.

6. The method according to claim 1, wherein the method further comprises:
obtaining, by the terminal device, indication information of the first area, wherein the indication information of the first area comprises any one or a combination of the following: a sequence number of the first area, an index of the first SSB, or information about a first frequency.

7. The method according to claim 1, wherein the method further comprises:
obtaining, by the terminal device, information about a first time period, wherein the first time period is effective time of the satellite type corresponding to the first area.

8. The method according to claim 1, wherein the determining, by the terminal device based on the satellite type, whether to access a network device covering the first area comprises:
determining, by the terminal device, a first satellite type of the network device covering the first area; and
if the first satellite type is the same as the satellite type corresponding to the first area, determining, by the terminal device, to access the network device; or if the first satellite type is different from the satellite type corresponding to the first area, determining, by the terminal device, not to access the network device.

9. The method according to claim 1, wherein the satellite type comprises an ascending orbit satellite or a descending orbit satellite.

10. A communication method, applied to a non-terrestrial network (NTN), comprising:
accessing, by a terminal device, a service satellite, wherein a type of the service satellite is a first satellite type;
measuring, by the terminal device, a satellite of a second satellite type to obtain a measurement result; and
when the measurement result meets a measurement event, reporting, by the terminal device, a measurement report corresponding to the measurement event to the service satellite, wherein the measurement report is used to trigger the service satellite to perform interference coordination with the satellite of the second satellite type.

11. The method according to claim 10, wherein the measurement event comprises that signal quality of the satellite of the second satellite type is higher than a specified threshold in a specified time period.

12. A communication method, applied to a non-terrestrial network (NTN), comprising:
obtaining, by a terminal device, information of an electronic fence; and
performing, by the terminal device, a communication failure recovery process or a random access process based on the information of the electronic fence.

13. The method according to claim 12, wherein the performing, by the terminal device, a communication failure recovery process based on the information of the electronic fence comprises:
when a communication link failure occurs in a first area corresponding to the electronic fence, keeping, by the terminal device, inactivity in a first time period corresponding to the electronic fence.

14. The method according to claim 12, wherein the performing, by the terminal device, a random access process based on the information of the electronic fence comprises:
handing over, by the terminal device before a start moment of a first time period corresponding to the electronic fence, to a second area corresponding to an available frequency.
